(19) United States
(12) Patent Application Publication
(10) Pub. No.: US 2007/0280442 A1
(43) Pub. Date: Dec. 6, 2007

(54) NETWORK-BASED VOICE OVER POWER LINES (VoPL) SYSTEM AND METHODS

(76) Inventor: Youjuan ZHANG, Shenzhen (CN)

Correspondence Address: MATTHIAS SCHOLL, 14781 MEMORIAL DRIVE, SUITE 1319, HOUSTON, TX, 77079, US

(21) Appl. No.: 11/736,582

(22) Filed: Apr. 18, 2007

(30) Foreign Application Priority Data
Apr. 18, 2006 (CN) 200610075640.4

(51) Int. Cl. H04M 11/00

(52) U.S. Cl. 379/93.07

(57) ABSTRACT

Disclosed herein is a network-based voice over power lines (VoPL) telephone communication system, comprising a power line network, multiple clients and a server. The clients are respectively connected to the power line network for providing access for a user telephone and/or for providing a user operation interface. The server comprises at least one power interface and one telephone interface connected to the power line network, and to the clients via the power line network, for handling calls and transfer from the clients. The clients comprise power line adapters and/or power line telephones, the power line adapter comprises at least one power interface and one telephone interface for inputting numbers and/or information via keypads to make a call, and the power line telephone comprises at least one power interface for inputting numbers and/or information via keypads to make a call. An implementation method for a network-based voice over power lines (VoPL) telephone communication system is also disclosed herein.

### CROSS-REFERENCE TO RELATED APPLICATIONS

This application claims priority to Chinese Patent Application No. 200610075640.4 filed on Apr., 18, 2006, the contents of which are incorporated herein by reference.

### BACKGROUND OF THE INVENTION

1. Field of the Invention

This invention relates generally to a telephone communication system and method for implementing the same, and particularly to a network-based voice over power lines (VoPL) system and methods.

2. Description of the Related Art

In conventional land-line telephone system every telephone number occupies one channel of a telephone switch and each of the user circuits is an independent physical line. Regardless of whether a user uses the physical line to make a call, the physical line is always “occupied.” While this mode may guarantee communication and quality, it also squanders resources. Specifically, an enormous expense of establishing and maintaining end user lines is always a big part of operating expenditure. For the same reason, the layout and maintenance of user lines in telephone switching systems is a very complex and costly task in terms of difficulty, complexity and cost of engineering, and its expense often outweighs that of devices.

With the advent of novel communication technologies, various technical standards and protocols (notably, the H.323 protocol stack and the Session Initiation Protocol (SIP) stack which provide real-time video, audio and data communication services) are replacing a traditional fixed telephone and indeed solve certain practical problems. However, most novel layer protocols are all based on the Internet Protocol (IP) network, and require the existence of a broadband network. Although, after decades of development, the broadband network becomes increasingly popular, it still faces a same problem as the traditional telephone system, and the expense of laying out and maintaining broadband lines is enormous.

Indeed, there have been many improvements in the recent years, especially with the development of the power line carrier technique and launch of the home plug powerline specification (HomePlug). The HomePlug specification provides vital bandwidth of 14M, 85M, 200M, and so on, allowing for growth of communication applications over power lines.

### SUMMARY OF THE INVENTION

An objective of the invention is to provide a user telephone communication system over a power line network, which is capable of utilizing existent power line network to implement user telephone communication, so as to decrease the expense of establishing and maintaining end user lines and of laying out and maintaining user lines in a user telephone switching system. Meanwhile, communication quality of the user telephone communication system of the invention may compete with the conventional telephone communication system.

It is another objective of the invention to provide an implementation method for a network-based voice over power lines (VoPL) telephone communication system which assures high-quality communication, and decreases the expense for layout and maintenance.

To achieve the above objectives, in accordance with one embodiment of the invention, provided is a network-based voice over power lines (VoPL) telephone communication system comprises a power line network, multiple clients and a server. The clients are respectively connected to the power line network for providing access for a user telephone, and/or for providing a user interface. The server comprises at least one power interface and one telephone interface connected to the power line network and to the clients via the power line network for handling calls and transferring calls from the clients. The clients comprise power line adapters and/or power line telephones. The power line adapter comprises at least one power interface and one telephone interface for inputting numbers and/or information via keypads, e.g., to make a call. The power line telephone comprises at least one power interface for inputting numbers and/or information via keypads, e.g., to make a call.

In certain classes of this embodiment, the server further comprises at least one wide area network (WAN) interface and/or at least one local area network (LAN) interface connected to the Internet.

In certain classes of this embodiment, the server is configured as a power line switch.

In certain classes of this embodiment, the power line adapter further comprises at least one LAN interface, and the power line switch further comprises at least one LAN interface.

In certain classes of this embodiment, the telephone interface is configured as a RJ11 interface, an E1 interface, a T1 interface, or an optical fiber interface.

In certain classes of this embodiment, the WAN interface is configured as a RJ45 interface or an optical fiber interface, and the LAN interface is configured as a RJ45 interface or an optical fiber interface.

In certain classes of this embodiment, the LAN interfaces of both the power line adapter and the power line telephone are configured as the RJ45 interface or a USB interface.

In other aspects the invention provides an implementation method for a power-line-network-based user telephone communication system, comprising: a) configuring a server to connect to the power line network, and the clients to connect to the power line network, the server connected to the clients via power line network, the server configured as a power line switch, and the clients respectively configured as a power line adapter and/or a power line telephone; b) configuring the power line switch to comprise at least one power interface and one telephone interface, the power line adapter to comprise at least one power interface and one telephone interface, and the power line telephone to comprise at least one power interface; c) forwarding a call from an external telephone of the power line network to a called internal telephone according to a preset protocol by the server as the external telephone dials the internal telephone, to establish a traffic link and connection therebetween, and releasing the traffic link as the communication is terminated; and d) searching for address information of a called telephone according to a preset protocol by the server as the internal telephone of the power line network dials the external telephone thereof, forwarding the call to the called external telephone by the telephone interface of the server if the address information is an external number of the power line network, so as to establish a traffic link and communication; directly making a call to establish communication if the address information is an internal number of the power line network, releasing the traffic link as the communication is terminated.

In certain classes of this embodiment, step b) further comprises configuring the power line switch to comprise at least one wide area network (WAN) interface, and the power line adapter and the power line telephone to comprise at least one local area network (LAN) interface.

In certain classes of this embodiment, step b) further comprises configuring the power line switch to comprise at least one LAN interface, the power line adapter to comprise at least one LAN interface, and the power line telephone to comprise at least one LAN interface.

In certain classes of this embodiment, step b) further includes configuring the WAN interface of the power line switch as a RJ45 interface or an optical fiber interface, for connecting to the Internet.

In certain classes of this embodiment, step b) further includes configuring the LAN interface of the power line switch as the RJ45 interface or the optical fiber interface, for connecting to the Internet.

In certain classes of this embodiment, step b) further includes configuring the telephone interface of the power line switch as an E1 interface, a T1 interface, a RJ11 interface or the optical fiber interface.

In certain classes of this embodiment, step b) further includes configuring the LAN interface of the power line adapter as the RJ45 interface or a USB interface.

In certain classes of this embodiment, step b) further includes configuring the LAN interface of the power line telephone as the RJ45 interface or the USB interface.

In certain classes of this embodiment, step c) includes forwarding a call from an external telephone of the power line network to a called internal telephone thereof according to a preset protocol by the server via the LAN interface as the external telephone dials the internal telephone, to establish a traffic link and communication therebetween.

In certain classes of this embodiment, step d) includes transmitting a called number via keypads of the client as the internal telephone of the power line network dials the external telephone thereof, so as to comply with a specification of a public telephone network.

In certain classes of this embodiment, step d) further includes forwarding the called number to the called external telephone of the power line network according to a preset protocol by the server via the WAN interface, to establish the traffic link and the connection.

The power-line-network-based user telephone communication system of the invention provides the following general advantages: (1) it is possible to utilize an existent power line network to provide and implement a user telephone communication system to facilitate user telephone communication, so as to decrease expense of establishing and maintaining end user lines, and of laying out and maintaining user lines in a user telephone switching system; and (2) communication quality of the user telephone communication system of the invention may compete with the present telephone communication system, and complies with a specification of a public telephone network.

### BRIEF DESCRIPTION OF THE DRAWINGS

The invention is described hereinafter with reference to accompanying drawings, in which:

FIG. 1 illustrates a user telephone communication system in accordance with one embodiment of the invention;

FIG. 2 illustrates an external interface of a power line switch system in accordance with one embodiment of the invention;

FIG. 3 illustrates an external interface of a power line adapter system in accordance with one embodiment of the invention;

FIG. 4 illustrates an external interface of a power line telephone system in accordance with one embodiment of the invention;

FIG. 5 illustrates steps of an implementation method in accordance with one embodiment of the invention; and

FIG. 6 is a schematic diagram of a PSTN interface as shown in FIGS. 2 and 3.

### DETAILED DESCRIPTION OF THE INVENTION

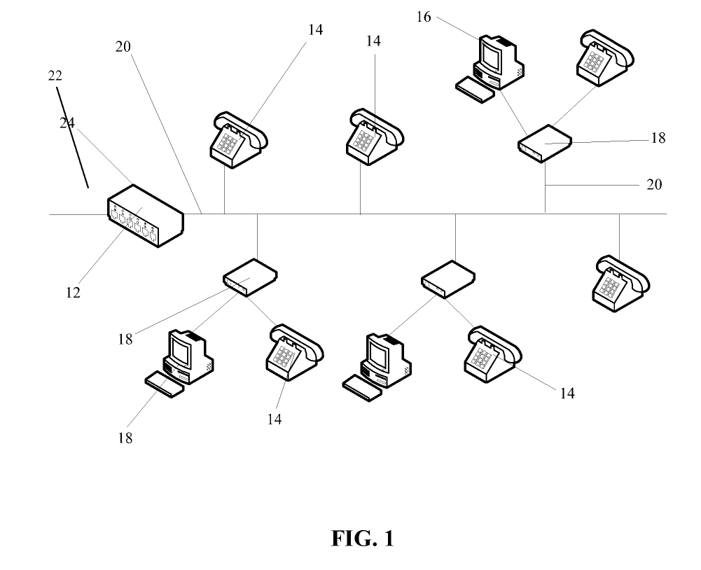

As shown in FIG. 1, a power line switch 12, functioning as a server, is connected to a power line network 20; also, a power line telephone 14 and a power line adapter 18, functioning as clients, are connected to the power line network 20. An Ethernet interface on the power line adapter 18 is connected to a computer 16. Generally, there are multiple clients.

At least one telephone interface 22 and one power interface are connected to an external public telephone network and a power line network 20, respectively, and are configured on the power line switch 12. At least one Ethernet interface 24 connected to the Internet may also be configured thereon. At least one power interface and one telephone interface are configured on the power line adapter 18; the power interface is connected to the power line network 20, and the telephone interface is connected to the power line telephone 14. At least one Ethernet interface may also be configured on the power line adapter 18, for connecting to network equipments. At least one power interface is configured on the power line telephone 14 for connecting to the power line network 20. Moreover, an Ethernet interface may also be configured thereon for connecting to network equipments.

In this embodiment, the telephone interface 22 on the power line switch 12 may be configured as an E1 interface complying with an European rate specification, a T1 interface, a RJ11 interface, an optical fiber interface complying with US and Japanese rate specifications, or any other appropriate interfaces. The Ethernet interface 24 of the power line switch 12 includes a WAN interface and a LAN interface, and may be configured as a crystal head RJ45 interface, a fiber distributed data interface (FDDI), or any other appropriate interfaces.

In this embodiment, the telephone interface on the power line adapter 18 is configured as a RJ11 interface. The Ethernet interface on the power line adapter 18 employs the LAN interface, and is configured as the crystal head RJ45 interface or a universal serial bus (USB) interface.

In this embodiment, the Ethernet interface on the power line telephone 14 employs the LAN interface, and is configured as the crystal head RJ45 interface or the USB interface.

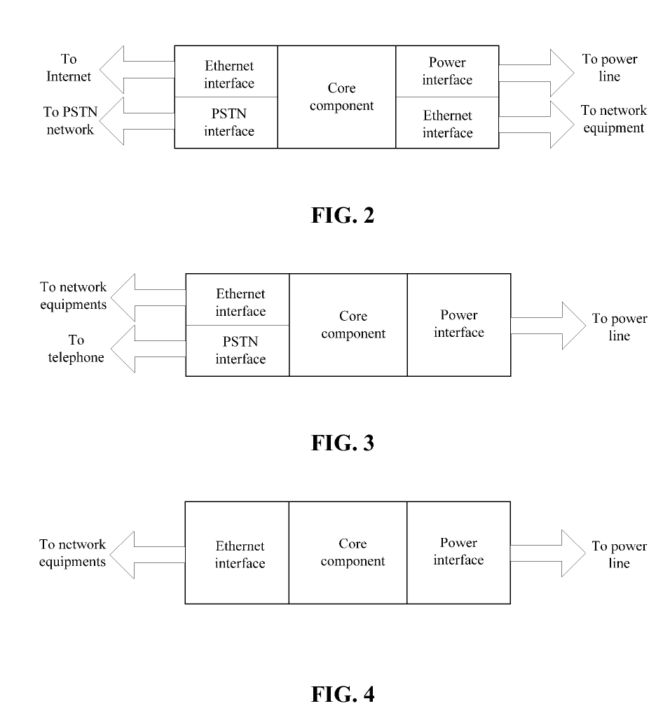

As shown in FIGS. 2, 3 and 4, interfaces of the power line switch 12, the power line adapter 18 and the power line telephone 14 of the invention are illustrated.

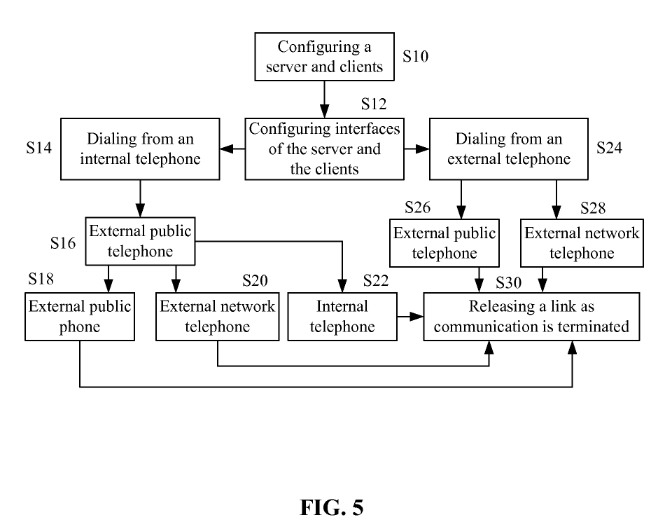

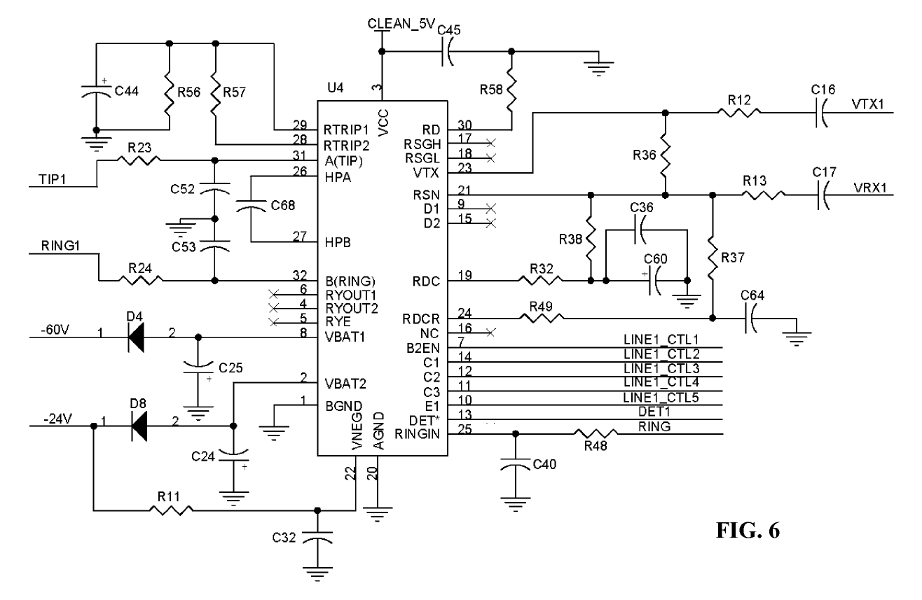

As shown in FIG. 5, the implementation process begins with step s10, where a server and a plurality of clients are configured on a power line network. Preferably, the server is configured as a power line switch, and the clients are configured as a power line adapter and a power line telephone. Both the server and the clients are connected on the power line network, and interoperate with each other via power lines.

The process then proceeds to step s12, where at least one telephone interface and one power interface respectively connected to an external public telephone network and a power line network are configured on the power line switch and at least one Ethernet interface connected to the Internet is also configured thereon. At least one power interface and one telephone interface are configured on the power line adapter for respectively connecting to the power line network and the power line telephone. At least one Ethernet interface is also configured thereon for connecting to network equipments. At least one power interface is configured on the power line telephone for connecting to the power line network, an Ethernet interface is also in certain implementations configured thereon for connecting to the network equipments.

In this embodiment, the telephone interface 22 on the power line switch 12 is configured as an E1 interface complying with European rate specification, a T1 interface, a RJ11 interface and an optical fiber interface complying with US and Japanese rate specifications, or any other appropriate interfaces. The Ethernet interface of the power line switch includes a WAN interface and a LAN interface, and is configured as a crystal head RJ45 interface, a fiber distributed data interface (FDDI), or any other appropriate interfaces.

In this embodiment, the telephone interface on the power line adapter 18 is configured as a RJ11 interface. The Ethernet interface on the power line adapter 18 employs the LAN interface, and is in certain implementations configured as the crystal head RJ45 interface or a universal serial bus (USB) interface.

In this embodiment, the Ethernet interface on the power line telephone 14 employs the LAN interface, and is in certain implementations configured as the crystal head RJ45 interface or the USB interface.

The process then proceeds to step s14, where an internal telephone dials an external telephone of the power line network. The process then proceeds to step s16, where the server searches for address information of the called telephone according a preset protocol. If the called telephone is an external public telephone, the process proceeds to step s18, where the call is forwarded to the called external telephone via the telephone interface of the server to establish communication. If the called telephone is an external network telephone, the process proceeds to step s20, where the call is forwarded to the called external network telephone via the Ethernet interface to establish a traffic link, and finally, communication. If the called telephone is an internal telephone, the process proceeds to step s22, where a direct call is made to establish communication.

Step s14 is in certain implementations synchronous with step s24, where the external telephone dials the internal telephone, followed by step s26 and s28, where the external public telephone and the external network telephone dial respectively. However, it is required that the server forwards the calls to the called internal telephone according to the preset protocol, to establish a traffic link and communication therebetween.

Each of the steps s18, s20, s22, s26 and s28 is followed by step s30, where the communication is terminated, and the traffic link is released and unoccupied.

In step s14, as the internal telephone dials the external network telephone of the power line network, the called number is firstly transmitted via keypads of the clients, so as to comply with the specification of a public telephone network.

Source code for implementing steps s20, s22, s24, s28 and s30 are illustrated below:

```
switch (sip_state) {
  case SIP_STATE_IDLE:
    if ( !strncmp(uip_appdata,“INVITE”,6) ) {
```

| | |
|---|---|
| pTemp = t_strstr(uip_appdata, “from:”); | // get sender's |
| | user name |

```
      pTemp = t_strstr(pTemp, “sip:”) + 4;
      t_memccpy(remoteUsername, pTemp, ‘@’,
      USERNAME_LENGTH);
```

| | |
|---|---|
| pTemp = t_strstr(uip_appdata, “call-id:”) + 9; | // get CALL-ID |

t_memccpy(callID, pTemp, ‘\r’, CALLID_LENGTH);

| | |
|---|---|
| getCseq( ); | // get cseq |
| getTag(1); | // get sender's tag |
| getVia( ); | // get sender's |
| | Contact Url |
| getRTPAddressPort( ); | // get sender's |
| | RTP address and |
| | port |
| send180( ); | // send 180 and |
| | start ringing |

```
      sip_state = SIP_STATE_RING;
    }
    else if ( !strncmp(uip_appdata,“BYE”,3) ) {
      getVia( );
      send200(1);
    }
    else if ( !strncmp(uip_appdata, “SIP/2.0 487”, 11) ) {
      sendAck( );
      processed = 1;
    }
    else if (!strncmp(uip_appdata, “SIP/2.0 486”, 11)) {
      sendAck( );
      processed = 1;
    }
    break;
  case SIP_STATE_RINGING:
    if ( !strncmp(uip_appdata, “SIP/2.0 200”, 11) ) {
```

| | |
|---|---|
| getTag(0); | // get sender's tag |
| getContact( ); | // get sender's Contact Url |
| getRTPAddressPort( ); | // get sender's RTP address and port |
| getRoute( ); | // get router info. |
| sendAck( ); | // send ACK, and start talking |

```
      sip_state = SIP_STATE_ESTABLISHED;
      Disp_LCD(3, &sip_state, 1);
      G723_Work_Start( );
    }
    else if (!strncmp(uip_appdata, “SIP/2.0 486”, 11)) {
      sendAck( );
      sip_state = SIP_STATE_IDLE;
      processed = 1;
    }
    break;
  case SIP_STATE_RING:
```

| | |
|---|---|
| if ( !strncmp(uip_appdata,“CANCEL”,6) ) { | // cancel call |

```
      pTemp = t_strstr(uip_appdata, “cseq:”) + 6;
      t_memccpy(cseqNumberCancel, pTemp, ‘ ’, CSEQ_LENGTH);
      send200(2);
      sip_state = SIP_STATE_CANCELED;
    }
```

| | |
|---|---|
| else if ( !strncmp(uip_appdata,“INVITE”,6) ) { | // re-send 180 |
| send180( ); | |
| } | |
| break; | |
| case SIP_STATE_OK: | |

| | |
|---|---|
| if ( !strncmp(uip_appdata,“ACK”,3) ) { | // start talking |
| Disp_LCD(3, &sip_state, 1); | |
| sip_state = SIP_STATE_ESTABLISHED; | |
| G723_Work_Start( ); | |
| } else if ( !strncmp(uip_appdata,“INVITE”,6) ) { | // re-send 200 |
| send200(0); | |
| } | |
| break; | |
| case SIP_STATE_ESTABLISHED: | |

| | |
|---|---|
| if ( !strncmp(uip_appdata,“BYE”,3) ) { | // get BYE request |

```
      getVia( );
      send200(1);
      sip_state = SIP_STATE_IDLE;
      Disp_LCD(3, &sip_state, 1);
      G723_Work_Stop( );
    }
    else if ( !strncmp(uip_appdata, “SIP/2.0 200”, 11) ) {
      sendAck( );
    }
    break;
..................
  case SIP_STATE_CANCEL:
    if ( !strncmp(uip_appdata, “SIP/2.0 487”, 11) ) {
      sendAck( );
      sip_state = SIP_STATE_IDLE;
      processed = 1;
    }
    break;
  case SIP_STATE_CANCELED:
    if ( !strncmp(uip_appdata,“CANCEL”,6) ) {
      send200(2);
    }
    break;
  case SIP_STATE_TERMINATING:
    if ( !strncmp(uip_appdata,“ACK”,3) ) {
      sip_state = SIP_STATE_IDLE;
    } else if ( !strncmp(uip_appdata,“CANCEL”,6) ) {
      send200(2);
      sip_state = SIP_STATE_CANCELED;
    }
    break;
  case SIP_STATE_BUSY:
    if ( !strncmp(uip_appdata,“ACK”,3) ) {
      sip_state = SIP_STATE_IDLE;
    }
    break;
  default:
    break;
  }
```

In FIG. 6 shown is a schematic diagram of a PSTN interface illustrated in FIGS. 2 and 3.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A network-based voice over power lines (VoPL) telephone communication system, comprising
a power line network;
a plurality of client(s) electrically connected to the power line network; and
a server comprising at least one power interface and one telephone interface connected to the power line network, connected to the clients via the power line network;
wherein
each client is a power line adapter and/or a power line telephone;
the power line adapter comprises at least one power interface and one telephone; and
the power line telephone comprises at least one power interface for inputting numbers and/or information via the keypads to make a call.

2. The system of claim 1, wherein the server further comprises at least one wide area network (WAN) interface and/or at least one local area network (LAN) interface connected to the Internet.

3. The system of claim 2, wherein the WAN interface is configured as a RJ45 interface or an optical fiber interface, and the LAN interface is configured as a RJ45 interface or an optical fiber interface.

4. The system of claim 1, wherein the server is configured as a power line switch.

5. The system of claim 4, wherein the LAN interfaces of both the power line adapter and the power line telephone are configured as the RJ45 interface or a USB interface.

6. The system of claim 1, wherein the power line adapter further comprises at least one LAN interface, and the power line switch further comprises at least one LAN interface.

7. The system of claim 1, wherein the telephone interface is configured as a RJ11 interface, an E1 interface, a T1 interface or an optical fiber interface.

8. A method for using the system of claim 1, comprising:
a) configuring the server to connect to the power line network, and the clients to connect to the power line network, the server connected to the clients via the power line network, the server configured as a power line switch, and the clients respectively configured as a power line adapter and/or a power line telephone;
b) configuring the power line switch to comprise at least one power interface and one telephone interface, the power line adapter to comprise at least one power interface and one telephone interface, and the power line telephone to comprise at least one power interface;
c) forwarding a call from an external telephone of the power line network to a called internal telephone according to a preset protocol by the server as the external telephone dials the internal telephone, to establish a traffic link and connection therebetween, and releasing the traffic link as the communication is terminated; and
d) searching for address information of a called telephone according to a preset protocol by the server as the internal telephone of the power line network dials the external telephone thereof; forwarding the call to the called external telephone by the telephone interface of the server if the address information is an external number of the power line network, so as to establish a traffic link and communication; if the address information is an internal number of the power line network directly making a call to establish communication; and releasing the traffic link as the communication is terminated.

9. The method of claim 8, wherein step (b) comprises configuring the power line switch to comprise at least one wide area network (WAN) interface, and the power line adapter and the power line telephone to comprise at least one local area network (LAN) interface.

10. The method of claim 9, wherein step (b) further comprises configuring the power line switch to comprise at least one LAN interface, the power line adapter to comprise at least one LAN interface, and the power line telephone to comprise at least one LAN interface.

11. The method of claim 10, wherein step (b) further comprises configuring the WAN interface of the power line switch as a RJ45 interface or an optical fiber interface, for connecting to the Internet.

12. The method of claim 11, wherein step (b) further comprises configuring the LAN interface of the power line switch as the RJ45 interface or the optical fiber interface, for connecting to the Internet.

13. The method of claim 12, wherein step (b) further comprises configuring the telephone interface of the power line switch as an E1 interface, a T1 interface, a RJ11 interface or the optical fiber interface.

14. The method of claim 13, wherein step (b) further comprises configuring the LAN interface of the power line adapter as the RJ45 interface or a USB interface.

15. The method of claim 13, wherein step (b) further comprises configuring the LAN interface of the power line telephone as the RJ45 interface or the USB interface.

16. The method of claim 8, wherein step (c) comprises forwarding a call from an external telephone of the power line network to a called internal telephone thereof according to a preset protocol by the server via the LAN interface as the external telephone dials the internal telephone, to establish a traffic link and communication therebetween.

17. The method of claim 8, wherein step (d) comprises transmitting a called number via keypads of the client as the internal telephone of the power line network dials the external telephone thereof, so as to comply with a specification of a public telephone network.

18. The method of claim 17, wherein step (d) further comprises forwarding the called number to the called external telephone of the power line network according to a preset protocol by the server via the WAN interface, to establish the traffic link and the connection.
